(19) United States
(12) Patent Application Publication
(10) Pub. No.: US 2025/0318511 A1
(43) Pub. Date: Oct. 16, 2025

(54) BRAKE FOR BAIT CASTING REEL WITH SQUARE COLUMN MAGNET

(71) Applicant: COCUS CO.,LTD., Bucheon-si (KR)

(72) Inventors: Eun Ki SIM, Incheon (KR); Geumchae NAM, Incheon (KR)

(21) Appl. No.: 18/668,211

(22) Filed: May 19, 2024

(30) Foreign Application Priority Data
Apr. 11, 2024 (KR) 10-2024-0048684

(51) Int. Cl. A01K 89/033; A01K 89/015

(52) U.S. Cl. CPC A01K 89/045; A01K 89/0192; A01K 89/01931

(57) ABSTRACT

The present invention provides a brake for a bait casting reel with square column magnets, which includes: a spool installed between both sides of a left-right frame; a double ring-shaped magnet brake ring coupled to one end of a spool shaft; a magnet housing coupled to the magnet brake ring; a plurality of square column magnets mounted in a circumferential direction between the magnet brake ring and the magnet housing; a spool cover in which the magnet housing is accommodated; a first control dial slider configured to move the plurality of square column magnets forward or backward within the spool cover; a second control dial slider engaged with the first control dial slider to move it forward or backward; and a control dial which is gear-coupled with the second control dial slider to drive it upon rotation.

### CROSS REFERENCE TO RELATED APPLICATIONS

This application claims the benefit of Korean Patent Application No. 10-2024-0048684 filed on Apr. 11, 2024, the entirety of which is incorporated by reference herein.

### BACKGROUND OF THE INVENTION

### 1. Field of the Invention

The present invention relates to a brake for a bait casting reel with square column magnets, and more specifically, to a brake for a bait casting reel with square column magnets, which is installed inside a bait casting reel attached to/detached from a fishing rod to control a braking force against rotation of a spool.

### 2. Description of the Related Art

Unless otherwise indicated herein, the contents described in this section are not prior art to the claims of the present application, and inclusion in this section is not admitted to be the prior art.

In general, as shown in FIGS. 1A and 1B, a bait casting reel 100 (hereinafter, briefly referred to as a bait reel) for fishing includes: a left-right body frame 140 which serves as an overall frame in appearance; a gear side cover 150 and a palm side cover 160 which are coupled to both sides of the left-right body frame 140 to provide an inner installation space; a reel handle 110, a star drag 120, a spool 200 and a thumb bar 170, which serve to wind or unwind the fishing line; a power transmission mechanism, a brake mechanism and a clutch (not denoted with numerals), which are provided therein; and a reel foot which is formed on a lower side and allows the bait reel 100 to be placed on a reel seat of the fishing rod.

Here, when pressing a thumb bar and setting the clutch in an off state to cast the fishing line, the spool rotates with acceleration while the fishing line wound on the spool begins to be released therefrom during casting. That is, if the spool continues to rotate due to inertia even after a bait falls into water, and the fishing line released its own, backlash called a reverse winding phenomenon, in which the fishing line is wound reversely onto the spool, occurs.

In this case, as a way of preventing the above situation, a user performs an operation called thumbing, which is a method of controlling the speed of the spool while slightly reducing by gently placing his or her finger on the rotating spool to cause friction before the casted fishing line touches the surface of water.

However, a considerable amount of experience is required for a user of the bait reel to perform the thumbing operation smoothly as described above, and there is no choice but to go through a lot of trial and error to prevent backlash of the reverse winding phenomenon.

In consideration of these problems, conventionally, a method of installing a magnet brake using a force that interrupts magnetic fields generated between N and S poles, and controlling a rotational speed of the spool by adjusting a distance between the magnet brake and the spool has been proposed in the art.

However, in the conventional technologies proposed so far, since a plurality of magnets mounted on the magnet brake are generally formed in a cylindrical shape, a problem in which strengths of the magnetic fields (magnetic fluxes) are not uniform depending on the axial heights and positions of the mounted magnets themselves occurs. Accordingly, a problem in which the braking force of the magnet brake is also uneven is being raised.

In this regard, Korean Patent Laid-Open Publication No. 10-2023-0061807 (published on May 9, 2023) discloses a fishing reel having magnets arranged in a circumferential direction. However, in the above technology, a plurality of magnets for providing a braking force are formed and arranged in a cylindrical shape, such that the problem in which the strengths of the magnetic fields (magnetic fluxes) are not uniform depending on the axial heights and positions of the mounted magnets themselves, and thereby, the problem in which the braking force of the magnet brake is uneven as described above still exist.

### PRIOR ART DOCUMENT

### Patent Document

(Patent Document 1) Korean Patent Laid-Open Publication No. 10-2023-0061807 (published on May 9, 2023)

### SUMMARY OF THE INVENTION

The present invention is intended to improve the conventional problems in consideration of the above-described circumstances, and it is an object of the present invention to provide a magnet brake configured to control a braking force against rotation of a spool for a bait reel, in which square column magnets are applied thereto such that constant and uniform strengths of magnetic fields (magnetic fluxes) may be generated regardless of the axial height positions of the installed magnets themselves, and thereby giving a uniform and stable braking force.

In addition, another object of the present invention is to provide to a brake for a bait reel, in which a spool of a bait reel and a magnet brake ring may be separately prepared and then combined with each other even if the rotating spools have different shapes or the spools are made of different materials, thereby giving a uniform and stable braking force.

Further, another object of the present invention is to provide a brake for a bait reel, in which square column magnets are applied thereto, such that a volume of the magnets and thus a strength of the magnetic field are increased compared to the cylindrical magnets, thereby giving a relatively greater braking force.

Furthermore, another object of the present invention is to provide a brake for a bait reel, which may give an improved braking force by additionally forming an annular flange part in a magnet brake ring.

In addition, it is not limited to the technical problems as described above, and it is obvious that another technical problem may be derived from the following description.

To achieve the above objects, according to an aspect of the present invention, there is provided a brake for a bait casting reel with square column magnets, comprising: a spool installed between both sides of a left-right frame; a double ring-shaped magnet brake ring coupled to one end of a spool shaft; a magnet housing coupled to the magnet brake ring; a plurality of square column magnets mounted in a circumferential direction between the magnet brake ring and the magnet housing; a spool cover in which the magnet housing is accommodated; a first control dial slider configured to move the plurality of square column magnets forward or backward within the spool cover; a second control dial slider engaged with the first control dial slider to move it forward or backward; and a control dial which is gear-coupled with the second control dial slider to drive it upon rotation.

According to a preferred embodiment, the brake for a bait casting reel may further include a ring-shaped magnet retainer which is coupled to an upper circumference of the magnet housing, and protrudes inward to securely support the plurality of square column magnets.

According to a preferred embodiment, the magnet brake ring may include an upper ring with a small diameter, which is coupled to the spool shaft, and a lower ring with a large diameter, which mutually interferes with magnetic fields of the plurality of magnets moving forward or backward to exert a braking force, wherein the upper and lower rings may be integrally formed with each other.

According to a preferred embodiment, the lower ring of the magnet brake ring may have a horizontal flange-shaped protrusion formed on an upper portion thereof, thus to increase an area on which the braking force that mutually interferes with the magnetic fields of the plurality of magnets acts.

According to a preferred embodiment, the plurality of magnets may be arranged symmetrically about a centerline thereof and uniformly in a circumferential direction of the magnet housing.

According to a preferred embodiment, the plurality of magnets may be arranged symmetrically about the centerline thereof and uniformly in the circumferential direction of the magnet housing, and may include 6 or 8 magnets.

According to a preferred embodiment, the spool cover may have a circular recess formed in an outer central portion thereof and a central axis formed in the center thereof, such that the first control dial slider is axially coupled therewith to slide forward or backward.

According to a preferred embodiment, a slide cam spring may be inserted into the central axis, and the first control dial slider is axially coupled thereto, such that, when the first control dial slider is moved forward, the slide cam spring may be compressed, and when the first control dial slider is moved backward, the slide cam spring may be relaxed to be returned to its original position.

According to a preferred embodiment, the first control dial slider may be moved forward or backward by clockwise or counterclockwise rotation of the second control dial slider.

According to a preferred embodiment, the first control dial slider may be formed in a cap shape having cross-shaped protrusions on the upper portion thereof, and a pair of protrusions may have a vertical semicircular column shape so as to slid forward or backward by rotation of the second control dial slider.

According to a preferred embodiment, the upper cross-shaped protrusions of the first control dial slider may come into contact with a lower surface of the magnet housing to slide forward or backward.

According to a preferred embodiment, the first control dial slider may be engaged in spiral surface contact with the rotatable second control dial slider, and may slide forward or backward by rotation of the second control dial slider.

According to a preferred embodiment, a control dial clicker made of metal may be elastically supported inside of the second control dial slider, and a metallic sound may be generated as the control dial clicker rotates.

According to a preferred embodiment, the control dial clicker may have an annular ring shape whose one side is cut, and includes a protrusion formed on the other side thereof, and when rotating, the protrusion may be inserted into and removed from a concavo-convex part formed on a circumferential surface of the control dial to generate a metallic sound.

According to a preferred embodiment, the control dial may be formed inside of a palm side cover, and by opening a portion of the palm side cover, the control dial may be operated.

According to a preferred embodiment, the control dial may have a disk shape and may include a gauge indication part formed on an outside of an outer upper surface thereof, and a concavo-convex part may be formed on a circumferential surface of the control dial.

According to a preferred embodiment, strengths of magnetic fields formed between neighboring magnets of the plurality of square column magnets may be uniform regardless of the positions thereof in the axial direction.

According to a preferred embodiment, the plurality of square column magnets may form a rectangular hexahedron, and a ratio of a width to a length may be in a range of 1.0 to 1.5, the length may be greater than or equal to the width, and a thickness thereof may be smaller than the width.

According to a preferred embodiment, the plurality of square column magnets may form a trapezoidal hexahedron, and a ratio of an upper width to a lower width may be in a range of 1.1 to 2.0, and a thickness thereof may be smaller than a short horizontal length.

According to the present invention, by applying square column magnets for providing a braking force against rotation of a spool to the magnet brake of the bait reel, constant and uniform strengths of magnetic fields (magnetic fluxes) may be generated regardless of the axial height positions of the installed magnets themselves, thereby giving a uniform and stable braking force against rotation of the spool of the magnet brake.

In addition, the present invention may give a uniform and stable braking force, by separately preparing a spool of the bait reel and a magnet brake ring and then combining them even if the rotating spools have different shapes or made of different materials.

In addition, the present invention may give a relatively greater braking force by applying square column magnets mounted on the magnet brake, such that a volume of the magnets and thus a strength of the magnetic field may be increased compared to the cylindrical magnets, thereby giving a relatively greater braking force.

In addition, the present invention may give an improved braking force by additionally forming an annular flange part in the magnet brake ring.

The effects of the present invention are not limited to the above advantages, and those skilled in the art should understand that it includes all effects that can be deduced from the detailed description of the present invention or the configurations of the invention described in the claims.

### BRIEF DESCRIPTION OF THE DRAWINGS

The above and other objects, features and other advantages of the present invention will be more clearly understood from the following detailed description taken in conjunction with the accompanying drawings, in which:

FIGS. 1A and 1B (collectively “FIG. 1”) are an assembled perspective view and a plan view, respectively, of a brake for a bait reel with square column magnets according to an embodiment of the present invention;

FIG. 2 is an exploded view of the brake for a bait reel with square column magnets according to an embodiment of the present invention as seen from the top;

FIG. 3 is an exploded view of the brake for a bait reel with square column magnets according to an embodiment of the present invention as seen from the bottom;

FIGS. 4A, 4B and 4C (collectively “FIG. 4”) are a plan view, a cross-sectional view, and a partial perspective view, respectively, illustrating a brake minimum state in which a braking force of the brake for a bait reel with square column magnets according to an embodiment of the present invention is minimum.

FIGS. 5A, 5B and 5c (collectively “FIG. 5”) are a plan view, a cross-sectional view, and a partial perspective view, respectively, illustrating a brake maximum state in which the braking force of the brake for a bait reel with square column magnets according to an embodiment of the present invention is maximum.

FIGS. 6A and 6B (collectively “FIG. 6”) are a plan view and a transverse view illustrating an arrangement of square column magnets and magnetic fields in which magnets are arranged and magnetic fields are formed in the brake for a bait reel with square column magnets according to an embodiment of the present invention;

FIGS. 7A and 7A′ (collectively “FIG. 6”) are perspective views of an arrangement of square column (rectangular tetrahedron) magnets and magnetic fields with the magnetic housing 240 present and not present, respectively, and FIGS. 7B and 7B′ are perspective views of an arrangement of square column (trapezoidal hexahedron) magnets and magnetic fields with the magnetic housing 240 present and not present, respectively, such that FIGS. 7A, 7A′, 7B and 7B′ are perspective views illustrating the arrangement of rectangular hexahedron and trapezoidal hexahedron magnets and magnetic fields formed in the brake for a bait reel with square column magnets according to an embodiment of the present invention; and

FIGS. 8 and 8′ (collectively “FIG. 8”) are perspective views of an arrangement of conventional cylindrical magnets and magnetic fields with the magnetic housing 24 present and not present, respectively, illustrating the arrangement of cylindrical magnets and magnetic fields formed in the prior art.

### DETAILED DESCRIPTION OF THE INVENTION

Hereinafter, a brake for a bait reel with square column magnets according to a preferred embodiment will be described in detail with reference to the accompanying drawings.

For reference, in the drawings described below, each component is omitted or schematically illustrated for convenience and clarity, and the size of each component does not reflect an actual size. In addition, the same reference numerals are denoted to the same components throughout the specification, and reference numerals for the same components in individual drawings will be omitted. Further, the publicly known functions and configurations, which are judged to be able to make the purport of the present invention unnecessarily obscure will not be described in detail.

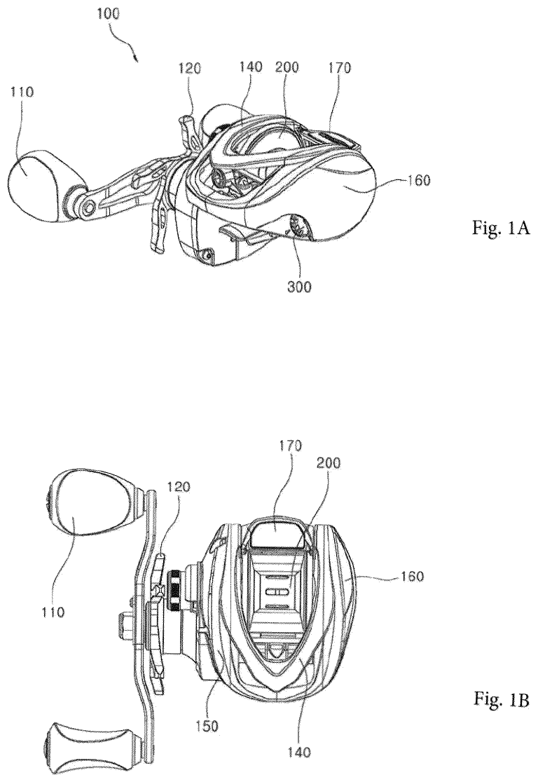

A preferred embodiment of the present invention will be described with reference to collective FIGS. 1 to 7. A brake 100 for a bait reel with square column magnets of the present invention is characterized by including: a spool 200 installed between both sides of a left-right frame 140; a double ring-shaped magnet brake ring 210 coupled to one end of a spool shaft 205; a magnet housing 240 coupled to the magnet brake ring 210; a plurality of square column magnets 230 mounted in a circumferential direction between the magnet brake ring 210 and the magnet housing 240; a spool cover 250 in which the magnet housing 240 is accommodated; a first control dial slider 270 configured to move the plurality of square column magnets 230 forward or backward within the spool cover 250; a second control dial slider 280 engaged with the first control dial slider 270 to move it forward or backward; and a control dial 300 which is gear-coupled with the second control dial slider 280 to drive it upon rotation.

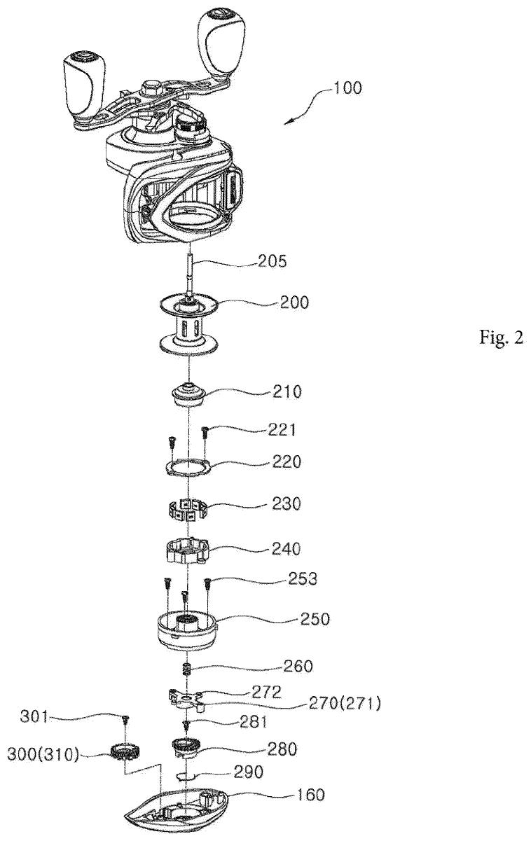

An operation of the brake 100 for a bait reel with square column magnets of the present invention will be described with collective reference to components shown in FIGS. 2 to 5.

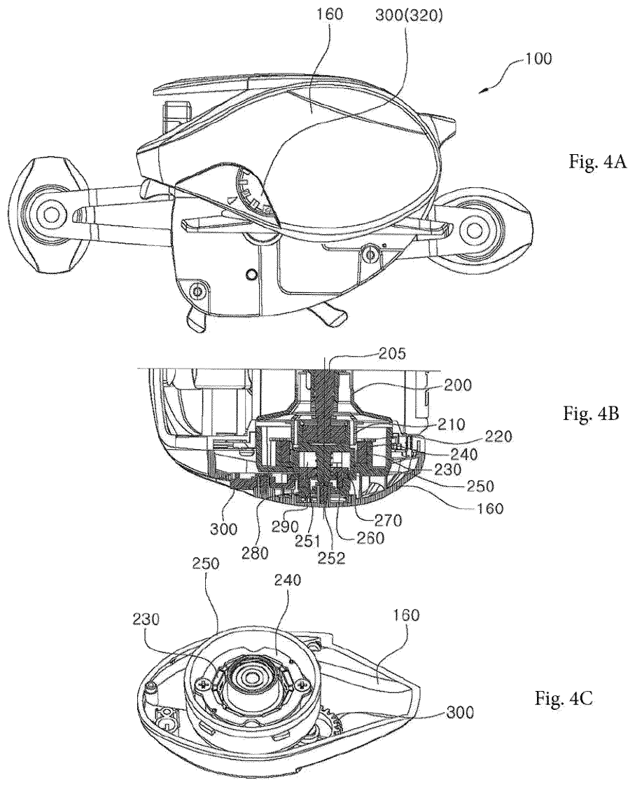

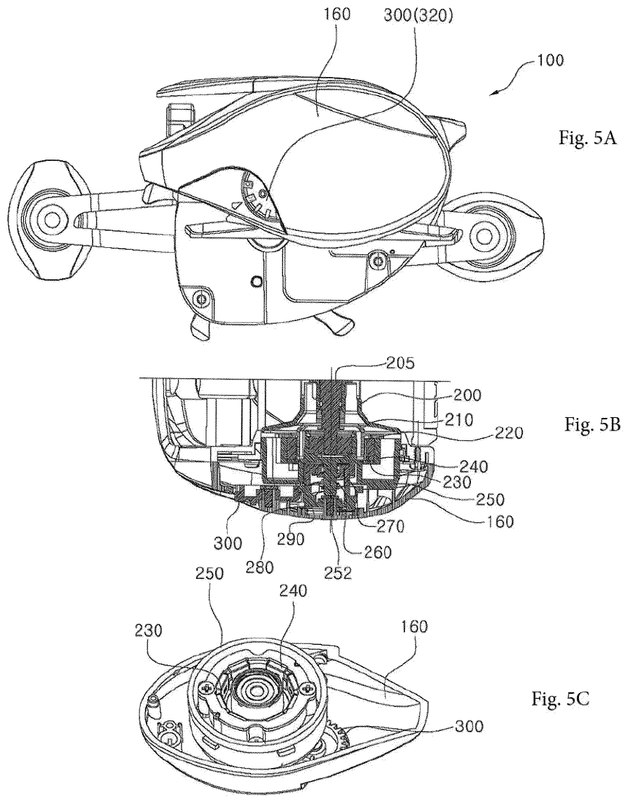

As shown collectively in FIGS. 4 and 5, first, when rotating the control dial 300, the gear-coupled second control dial slider 280 is rotated in conjunction therewith, and the engaged first control dial slider 270 which slides in surface contact with the same in a spiral cam manner (or rail manner) is moved forward.

Then, the magnet housing 240 accommodated in the spool cover 250 is pushed to be moved forward by cross-shaped protrusions 271 and 272 formed on an upper surface of the first control dial slider 270, and the plurality of magnets 230 mounted in the circumferential direction in the magnet housing 240 are moved forward to be close to an outer circumference of the magnet brake ring 210 fixed to the spool shaft 205 thus to cross each other in an axial direction, and thereby a braking force acts thereon. In this case, a slide cam spring 260 is coupled to a central axis 252 of the spool cover 250 to exert an elastic force to be compressed when moving the first control dial slider 270 forward, and relaxed and restored when moving backward.

In this situation, to increase or decrease the braking force, the braking force may be increased by increasing an axial crossing area, and conversely, the braking force of the magnet brake will be reduced when decreasing the axial crossing area.

According to the characteristics of the present invention, the magnet brake ring 210 is removable from the spool shaft 205. Therefore, even if the shape and material of the spool 200 are changed, the plurality of magnets 230 mounted in the magnet housing 240 always interact with the magnet brake ring 210. In this aspect, effects of providing constant and stable braking force may be achieved.

Meanwhile, when rotating the control dial 300 backward in a direction opposite to the forward direction, an operation opposite to the above-described process is performed. That is, the second control dial slider 280 gear-coupled to the control dial 300 may be moved backward and the first control dial slider 270 may also be moved backward by the restoring force of the slide cam spring 260 to be returned to its original position. At the same time, the accommodated magnet housing 240 in which the plurality of magnets 230 are mounted is also moved backward away from the magnet brake ring 210, such that the braking force of the magnet brake may be gradually reduced.

As described above, the brake 100 for a bait reel with square column magnets of the present invention may provide a uniform and stable braking force to the rotating spool 200 by the action of the square column magnets 230 cross-adjacent to the magnet brake ring 210 in the axial direction.

Next, major configurations of the brake 100 for a bait reel with square column magnets of the present invention will be described with reference collectively to FIGS. 2 to 7.

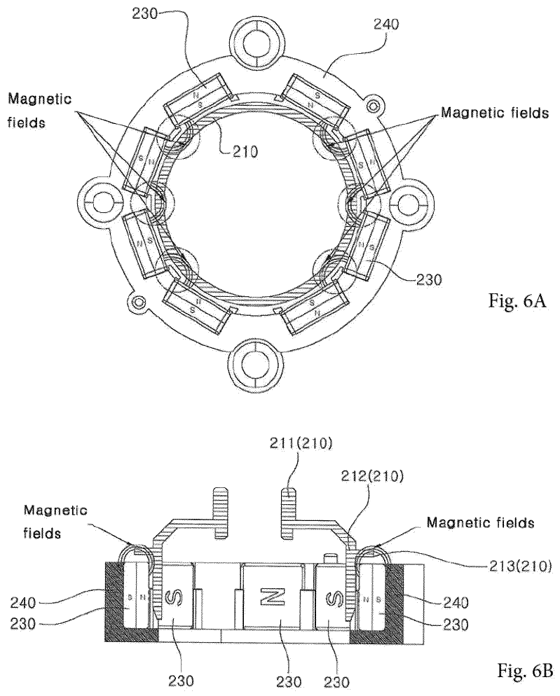

First, the magnet brake ring 210 of the present invention is detachably coupled to one end (palm side) of the spool shaft 205, and has a double ring shape including upper and lower rings as shown in FIGS. 6A and 6B, wherein an upper ring 211 has a relatively small diameter so as to be detachably coupled to the spool shaft 205, and a lower ring 212 has a relatively large diameter so as to move the magnet housing 240 forward or backward close to the outer circumference thereof. In this case, the magnet brake ring 210 may generate a braking force in the process of mutually interfering with or distorting the magnetic fields formed by N poles and S poles of the plurality of magnets 230 mounted in the circumferential direction inside the magnet housing 240.

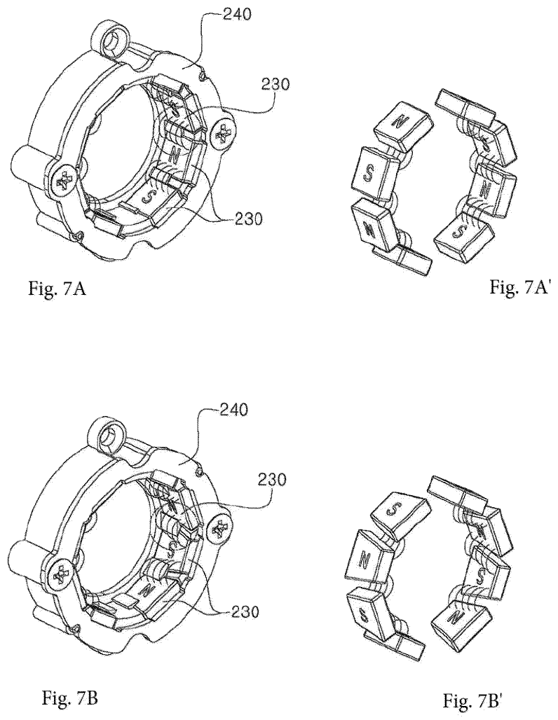

In addition, the plurality of magnets 230 of the present invention are mounted in the circumferential direction inside the magnet housing 240. Herein, as shown in collectively FIGS. 6 and 7, the magnets 230 are characterized in that the strengths of the magnetic fields formed between the neighboring magnets 230 are uniform regardless of the positions thereof in the axial direction.

That is, it is preferable that the plurality of square column magnets 230 form a rectangular hexahedron, and a ratio of a width to a length is in a range of 1.0 to 1.5, specifically, the length is greater than or equal to the width, and a thickness thereof is smaller than the width. In other words, the square column magnets 230 have a constant width (horizontal length) in a vertical direction (axial direction), such that the strengths of the magnetic fields acting on the neighboring magnets may be uniform and constant. To describe in more detail, the square column magnets 230 may give a higher magnetic force than the cylindrical magnets because the distances for each height are the same as each other and there is no difference in the magnetic force depending on the heights thereof. In addition, since the magnetic force is proportional to the volume, the magnetic force of the rectangular hexahedral square column magnets with a large volume of the single magnet is higher than that of the cylindrical magnets.

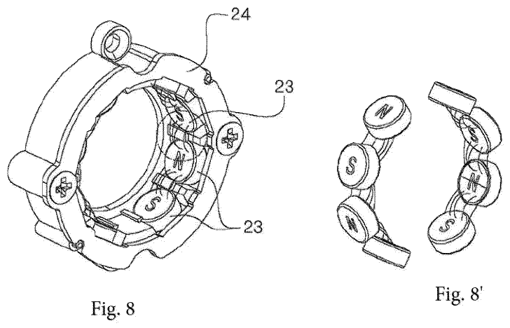

Meanwhile, unlike the characteristics of the present invention, the widths (horizontal lengths) of the conventional cylindrical magnets 23 shown in FIGS. 8 and 8′ are different depending on the positions thereof in the axial direction, and thereby, the strengths of the magnetic fields formed by the neighboring magnets 23 are also non-uniform and different depending on the positions thereof.

That is, a central portion in the horizontal length of the cylindrical magnet 23 has the largest diameter and the shortest adjacent distance with the neighboring magnets 23, thereby resulting in the greatest strength of the magnetic field. On the other hand, upper and lower portions in the axial direction of the cylindrical magnet 23 have the longest adjacent distance with the neighboring magnets 23, and the upper and lower portions of the cylindrical magnet 23 are in a minimum state in terms of the volume of the magnet, such that the magnetic flux density, which indicates the strength of the magnetic field, is also in a minimum state, thereby ultimately resulting in a significant difference in the strength of the magnetic field from that of the central portion in the horizontal length. To describe in more detail, the conventional cylindrical magnet 23 has the highest strength of the magnetic field at the central portion of the cylinder for each height and the lowest strength of the magnetic field at the outer diameter portions, i.e. the upper and lower portions, such that the magnetic force thereof is weaker than that of the square column magnet due to the difference in the magnetic field strength for each height. Therefore, since the strengths of the magnetic fields of the cylindrical magnets 23 are non-uniform depending on the positions thereof, it is difficult to provide a stable braking force to the rotating spool 200.

In addition, as shown in FIGS. 7B and 7B′, the plurality of magnets 230 of the present invention are characterized by forming a trapezoidal hexahedron, wherein upper and lower axial arrangements are disposed in a zigzag manner, so that the strengths of the magnetic fields formed between the neighboring magnets 230 are uniform regardless of the positions thereof in the axial direction.

That is, it is preferable that the plurality of square column magnets 230 form a trapezoidal hexahedron, and a ratio of an upper width to a lower width is in a range of 1.1 to 2.0, and a thickness thereof is smaller than a short horizontal length. In other words, a sum of the widths (horizontal lengths) of the trapezoidal hexahedral square column magnets 230 in the horizontal direction (axial direction) is constant at any position, such that the strengths of the magnetic fields acting with the neighboring magnets may be uniform and constant. To describe in more detail, like the rectangular hexahedron magnets, the square column magnets 230 also have the same distance for each height, such that there is no difference in the magnetic force depending on the heights thereof, and thereby the magnetic force is higher than the cylindrical magnets. In addition, since the magnetic force is proportional to the volume of the magnets, the magnetic force of the trapezoidal hexahedral square column magnets, which have a large volume of the single magnet, is higher than that of the cylindrical magnets.

Further, the first control dial slider 270 and the second control dial slider 280 of the present invention act in conjunction with the control dial 300 as described above, and are gear-coupled with the control dial 300, such that the second control dial slider 280 can be rotated in conjunction therewith. Here, the first control dial slider 270 may slide in surface contact with the same in a spiral cam manner (or rail manner) to be moved forward or backward.

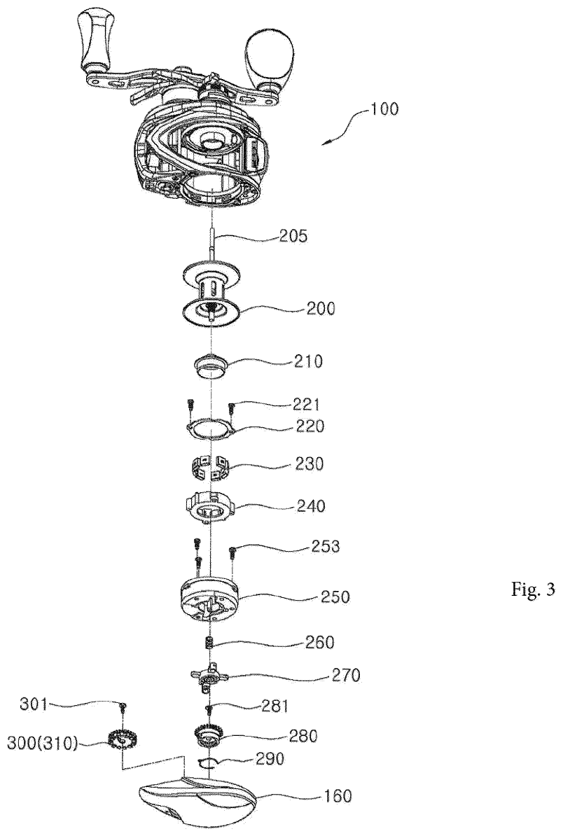

According to the characteristics of the present invention, as shown in FIGS. 2 and 3, a ring-shaped magnet retainer 220 is coupled to an upper circumference of the magnet housing 240, and protrudes inward to securely support the plurality of square column magnets 230.

According to the characteristics of the present invention, as collectively shown in FIGS. 4 and 5, the magnet brake ring 210 is configured in a way that the upper ring 211 with a small diameter, which is coupled to the spool shaft 205, and the lower ring 212 with a large diameter, which mutually interferes with the magnetic fields of the plurality of magnets 230 moving forward or backward to exert a braking force, are integrally formed with each other, such that it may be easy to separately detach from and attach to the spool shaft 205.

According to the characteristics of the present invention, as shown in FIGS. 6A and 6B, there are advantages that a flange-shaped annular protrusion 213 is horizontally formed on the upper portion of the lower ring 212 of the magnet brake ring 210 to increase the braking area so as to exert a braking force that mutually interferes with the magnetic fields of the plurality of magnets 230.

According to the characteristics of the present invention, as shown in FIGS. 6A and 6B, the plurality of magnets 230 may be arranged symmetrically about a centerline thereof and uniformly in the circumferential direction of the magnet housing 240, and the plurality of magnets 230 may include 6 or 8 magnets which are arranged uniformly and symmetrically about the centerline thereof in the circumferential direction of the magnet housing 240. The number of the magnets is not limited thereto, and of course, may be not less than or not more than 6 and 8 magnets as needed within the range where the purpose and effect of the present invention are equally achieved.

According to the characteristics of the present invention, as collectively shown in FIGS. 2 to 5, the spool cover 250 has a circular recess 251 formed in an outer central portion thereof and a central axis 252 formed in the center thereof, such that the first control dial slider 270 may be axially coupled therewith to slide forward or backward. In this case, a slide cam spring 260 is inserted into and coupled to the central axis 252, and the first control dial slider 270 is axially coupled thereto. Therefore, when the first control dial slider 270 is moved forward, the slide cam spring 260 is compressed, and when the first control dial slider 270 is moved backward, the slide cam spring 260 may be relaxed by the restoring force to be returned to its original position.

According to the characteristics of the present invention, as collectively shown in FIGS. 2 to 5, the first control dial slider 270 is moved forward or backward by clockwise or counterclockwise rotation of the second control dial slider 280 which is gear-coupled by the control dial 300. In this case, the first control dial slider 270 is formed in a cap shape having the cross-shaped protrusions 271 and 272 on the upper portion thereof, and a pair of protrusions 271 may have a vertical semicircular column shape so as to slid forward or backward by rotation of the second control dial slider 280. In addition, the upper cross-shaped protrusions 271 and 272 of the first control dial slider 270 may come into contact with a lower surface of the magnet housing 240 to slide forward or backward.

According to the characteristics of the present invention, as shown in FIGS. 2 and 3, a control dial clicker 290 made of metal is elastically supported inside of the second control dial slider 280, and a metallic sound is generated as the control dial clicker rotates. In this case, the control dial clicker 290 has an annular ring shape whose one side is cut, and includes a protrusion formed on the other side. When rotating, the protrusion is inserted into and removed from a concavo-convex part 310 formed on the circumferential surface of the control dial 300 to generate a metallic sound. Therefore, a user can operate the control dial 300 while detecting the metallic clicking sound.

In addition, as collectively shown in FIGS. 4 and 5, the control dial 300 is formed inside of the palm side cover 160, and by opening a portion of the palm side cover 160, the control dial 300 may be operated. The control dial 300 has a disk shape and includes a gauge indication part 320 formed on an outside of an outer upper surface thereof, such that the user may visually check the degree of rotation, that is, the braking force.

According to the characteristics of the present invention, the plurality of square column magnets 230 may be configured so that the strengths of the magnetic fields formed between the neighboring magnets 230 are uniform regardless of the positions thereof in the axial direction. To this end, the square column magnets 230 may be formed in the rectangular hexahedron or trapezoidal hexahedron shape to implement the above configuration as described above.

Although preferred embodiments of the present invention have been described with reference to the accompanying drawings, the embodiments and drawings described and illustrated in the present disclosure are simply the most preferred embodiment and do not represent all the technical sprites of the present invention, and it will be understood that various modifications and equivalents may be made to take the place of the embodiments at the time of filling the present application. Thus, it is clear that the above-described embodiments are illustrative in all aspects and do not limit the present disclosure. The scope of the present disclosure is defined by the following claims rather than by the detailed description of the embodiment. It shall be understood that all modifications and embodiments conceived from the meaning and scope of the claims and their equivalents are included in the scope of the present disclosure.

### DESCRIPTION OF REFERENCE NUMERALS

100: Brake for a bait casting reel with square column magnets
23, 24: Conventional cylindrical magnet, housing
110: Handle
120: Star drag
140: Frame
150: Gear side cover
160: Palm side cover
170: Thumb bar
200: Spool
205: Spool axis
210: Magnet brake ring
211: Upper ring
212: Lower ring
213: Flange-shaped protrusion
220: Magnet retainer
221: Bolt (screw)
230: Square pillar magnet
240: Magnet housing
250: Spool cover
251: Recess of spool cover
252: Central axis of spool cover
253: Bolt (screw)
260: Slide cam spring
270: First control dial slider
271, 272: Cross-shaped protrusions
280: Second control dial slider
281: Bolt (screw)
290: Control dial clicker
300: Control dial
301: Bolt (screw)
310: Concavo-convex part
320: Gauge indication part

What is claimed is:

1. A brake for a bait casting reel with square column magnets, comprising:
a spool installed between both sides of a left-right frame;
a double ring-shaped magnet brake ring coupled to one end of a spool shaft;
a magnet housing coupled to the magnet brake ring;
a plurality of square column magnets mounted in a circumferential direction between the magnet brake ring and the magnet housing;
a spool cover in which the magnet housing is accommodated;
a first control dial slider configured to move the plurality of square column magnets forward or backward within the spool cover;
a second control dial slider engaged with the first control dial slider to move it forward or backward; and
a control dial which is gear-coupled with the second control dial slider to drive it upon rotation.

2. The brake for a bait casting reel with square column magnets according to claim 1, further comprising a ring-shaped magnet retainer which is coupled to an upper circumference of the magnet housing, and protrudes inward to securely support the plurality of square column magnets.

3. The brake for a bait casting reel with square column magnets according to claim 1, wherein the magnet brake ring includes an upper ring with a small diameter, which is coupled to the spool shaft, and a lower ring with a large diameter, which mutually interferes with magnetic fields of the plurality of magnets moving forward or backward to exert a braking force, wherein the upper and lower rings are integrally formed with each other.

4. The brake for a bait casting reel with square column magnets according to claim 3, wherein the lower ring of the magnet brake ring has a horizontal flange-shaped protrusion formed on an upper portion thereof, thus to increase an area on which the braking force that mutually interferes with the magnetic fields of the plurality of magnets acts.

5. The brake for a bait casting reel with square column magnets according to claim 1, wherein the plurality of magnets are arranged symmetrically about a centerline thereof and uniformly in a circumferential direction of the magnet housing.

6. The brake for a bait casting reel with square column magnets according to claim 5, wherein the plurality of magnets are arranged symmetrically about the centerline thereof and uniformly in the circumferential direction of the magnet housing, and includes 6 or 8 magnets.

7. The brake for a bait casting reel with square column magnets according to claim 1, wherein the spool cover has a circular recess formed in an outer central portion thereof and a central axis formed in the center thereof, such that the first control dial slider is axially coupled therewith to slide forward or backward.

8. The brake for a bait casting reel with square column magnets according to claim 7, wherein a slide cam spring is inserted into the central axis, and the first control dial slider is axially coupled thereto, such that, when the first control dial slider is moved forward, the slide cam spring is compressed, and when the first control dial slider is moved backward, the slide cam spring is relaxed to be returned to its original position.

9. The brake for a bait casting reel with square column magnets according to claim 1, wherein the first control dial slider is moved forward or backward by clockwise or counterclockwise rotation of the second control dial slider.

10. The brake for a bait casting reel with square column magnets according to claim 9, wherein the first control dial slider is formed in a cap shape having cross-shaped protrusions on the upper portion thereof, and a pair of protrusions have a vertical semicircular column shape so as to slid forward or backward by rotation of the second control dial slider.

11. The brake for a bait casting reel with square column magnets according to claim 10, wherein the upper cross-shaped protrusions of the first control dial slider come into contact with a lower surface of the magnet housing to slide forward or backward.

12. The brake for a bait casting reel with square column magnets according to claim 9, wherein the first control dial slider is engaged in spiral surface contact with the rotatable second control dial slider, and slides forward or backward by rotation of the second control dial slider.

13. The brake for a bait casting reel with square column magnets according to claim 1, wherein a control dial clicker made of metal is elastically supported inside of the second control dial slider, and a metallic sound is generated as the control dial clicker rotates.

14. The brake for a bait casting reel with square column magnets according to claim 13, wherein the control dial clicker has an annular ring shape whose one side is cut, and includes a protrusion formed on the other side thereof, and when rotating, the protrusion is inserted into and removed from a concavo-convex part formed on a circumferential surface of the control dial to generate a metallic sound.

15. The brake for a bait casting reel with square column magnets according to claim 1, wherein the control dial is formed inside of a palm side cover, and by opening a portion of the palm side cover, the control dial is operated.

16. The brake for a bait casting reel with square column magnets according to claim 15, wherein the control dial has a disk shape and includes a gauge indication part formed on an outside of an outer upper surface thereof, and a concavo-convex part is formed on a circumferential surface of the control dial.

17. The brake for a bait casting reel with square column magnets according to claim 1, wherein strengths of magnetic fields formed between neighboring magnets of the plurality of square column magnets are uniform regardless of the positions thereof in the axial direction.

18. The brake for a bait casting reel with square column magnets according to claim 17, wherein the plurality of square column magnets form a rectangular hexahedron, and a ratio of a width to a length is in a range of 1.0 to 1.5, the length is greater than or equal to the width, and a thickness thereof is smaller than the width.

19. The brake for a bait casting reel with square column magnets according to claim 17, wherein the plurality of square column magnets form a trapezoidal hexahedron, and a ratio of an upper width to a lower width is in a range of 1.1 to 2.0, and a thickness thereof is smaller than a short horizontal length.
